(19) United States
(12) Patent Application Publication
(10) Pub. No.: US 2010/0178142 A1
(43) Pub. Date: Jul. 15, 2010

(54) Base structure for a truck bed extension and ramp system

(76) Inventors: Martin R. Noddin, Rollingdam (CA); Robert C. Noddin, Rollingdam (CA)

Correspondence Address: MARIO D. THERIAULT, 812 HWY. 101 NASONWORTH, FREDERICTON, NB, E3C 2B5, CA

(21) Appl. No.: 12/318,826

(22) Filed: Jan. 9, 2009

(51) Int. Cl. B60P 9/00; B65G 69/30

(52) U.S. Cl. 414/462; 14/71.1

(57) ABSTRACT

The base structure for a truck bed extension and ramp system has a horizontal U-shaped planar frame and dimensions for forming a margin over a tailgate of a pickup truck. A pair of posts extend vertically from the ends of the U-shaped frame. A tailgate-latch coupler is movably mounted on each post. This tailgate-latch coupler has dimensions for attachment to a tailgate latch member of a pickup truck. Each tailgate-latch coupler is movable up and down along the post and is connected to the tailgate latch member of a pickup truck and to retain the base structure to the truck box.

### FIELD OF THE INVENTION

This invention pertains to truck bed extensions, and more particularly, this invention pertains to a base structure for retaining a truck bed extension and ramp system to the box of a pickup truck.

### BACKGROUND OF THE INVENTION

The prior art contains numerous types of truck bed extensions. The following list provides a good sampling of the different designs available from the prior art.
US D485,800 issued to D. P. Smith, on Jan. 27, 2004;
U.S. Pat. No. 4,596,417 issued to K. D. Bennett, on Jun. 24, 1986;
U.S. Pat. No. 5,820,188 issued to K. M. Nash, on Oct. 13, 1.998;
U.S. Pat. No. 5,924,753 issued to D. R. DiBassie, on Jul. 20, 1999;
U.S. Pat. No. 6,227,593 issued to R. K. De Valcourt, on May 8, 2001;
U.S. Pat. No. 6,322,125 issued to C. E. Bauer, on Nov. 27, 2001;
U.S. Pat. No. 6,340,190 issued to R. Rosebrugh et al., on Jan. 22, 2002;
U.S. Pat. No. 6,378,926 issued to R. Renze et al., on Apr. 30, 2002;
US 2003/0127873 filed by H. F. Reed; published on Jul. 10, 2003;
CA 1,244,858 issued to J. J. Kardos, on Nov. 15, 1988;
CA 2,344,354 filed by D. Mussack et al.; published on Oct. 18, 2002;
CA 2,347,353 filed by H. W. Sanders; published on Sep. 21, 2002;
CA 2,366,149 issued to P. M. Burdon et al.; published on Jun. 21, 2003;
CA 2,369,494 filed by T. M. Fitts; published on Oct. 19, 2002;
CA 2,503,525 filed by R. Lantaigne; published on Oct. 6, 2006.

The prior art also contains numerous devices pertaining to tailgate support structures and tailgate ramp systems. The fields of tailgates and tailgate ramps are closely related to truck bed extensions and therefore a sampling of the references found therein is also mentioned herein below.
U.S. Pat. No. 729,840 issued to J. C. Butler et al., on Jun. 2, 1903;
U.S. Pat. No. 797,900 issued to R. Lowry, on Aug. 22, 1905;
U.S. Pat. No. 1,781,208 issued to D. B. Youngblood, on Nov. 11, 1930;
U.S. Pat. No. 3,148,912 issued to E. V. Curtis et al., on Sep. 15, 1964;
U.S. Pat. No. 3,319,811 issued to R. D. Martin, Jr., on May 16, 1967;
U.S. Pat. No. 5,156,432 issued to D. M. McCleary, on Oct. 20, 1992;
U.S. Pat. No. 5,273,339 issued to D. E. Flynn, on Dec. 28, 1993;
U.S. Pat. No. 5,342,105 issued to M. R. Miles, on Aug. 30, 1994;
U.S. Pat. No. 5,971,465 issued to M. Ives et al., on Oct. 26, 1999;
U.S. Pat. No. 5,988,725 issued to L. W. Cole, on Nov. 23, 1999;
U.S. Pat. No. 6,371,719 issued to L. J. Hildebrandt, on Apr. 16, 2002;
CA 446,929 issued to J. J. Black, on Mar. 2, 1948;
CA 2,297,621 filed by T. A. Shambeau; published on Oct. 15, 2000;
CA 2,418,606 filed by W. G. Walt; published on Aug. 10, 2004;

Box and tailgate dimensions of pickup trucks are substantially standard from one make of pickup trucks to another. The design of tailgate latches, however, varies from one make of trucks to another. For this reason, it becomes difficult to manufacture a truck bed extension that has standard features for mounting to different makes of pickup trucks.

Although each of the prior art devices has its own merits, prior advances in this field has not provided a standard mounting arrangement for retaining a truck bed extension to the box of any pickup truck. Therefore, a market need still exists for an universal base structure for retaining a truck bed extension to the box of a pickup truck.

### SUMMARY OF THE INVENTION

In one aspect of the present invention, there is provided a base structure having a horizontal U-shaped frame with dimensions similar to a tailgate of a pickup truck. A pair of posts extend vertically from the ends of the U-shaped frame. These posts are made to align with the rear vertical edges of a truck box on which the base structure is mounted. A tailgate-latch coupler is mounted on each post. This tailgate-latch coupler has dimensions for fitly connecting to a tailgate latch member of the pickup truck. Each tailgate-latch coupler comprises a chain link loosely encircling a respective post such that each tailgate-latch coupler is movable up and down along that post.

In use, each tailgate-latch coupler is moved to the proper height and is connected to the tailgate latch member of the pickup truck to retain the base structure to the truck box. These latch couplers are interchangeable from one type to another. Because of the interchangeable aspect of the couplers and because these tailgate-latch couplers are movable along their respective posts, the base structure is mountable on different models of pickup trucks.

In another aspect of the present invention the base structure is used to retain a bed extension to a pickup truck. The bed extension comprises a pair of foldable ramp members. In the bed extension mode, the ramp members are folded and laid edge-to-edge over each other. Both ramp members are laid edgewise over the U-shaped frame such as to form an extension of the truck box.

Each ramp member has hinge bushings on its extremities. Each post has sleeves affixed to its upper and lower ends. A pin is inserted through these sleeves and hinge bushings to retain both ramp members to the base structure.

The cross member of the U-shaped frame has anchor bushings affixed thereto. When the ramp members are in a deployed mode, the hinge bushings on the near extremities of the ramp members are aligned with the anchor bushings on the cross member and are affixed to the cross member by inserting the aforesaid pins through the anchor bushings and the hinge bushings.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

An embodiment of a base structure for a truck bed extension and ramp system is illustrated in the attached drawings. In these drawings the same numerals are used to identify the same elements. In the drawings;

FIG. 1 is a perspective rear and right side view of a pickup truck having the preferred base structure mounted therein and retaining a pair of ramp members in a deployed mode;

FIG. 1A is an enlarged view of the extremity on one of the ramp members;

FIG. 2 is a perspective rear and right side view of the pickup truck having both ramp members folded and laid edge-to-edge over the base structure thereby defining a truck bed extension over the tailgate of the pickup truck;

FIG. 3 is a rear and right side view of the preferred base structure, shown in isolation for clarity;

FIG. 3A is an enlarged partial view of the lower end of the left side post on the preferred base structure;

FIG. 3B is an enlarge partial view of the upper end of the right side post on the preferred base structure;

FIG. 4 is a perspective view of a first example of a latch coupler;

FIG. 5 is a perspective view of a second example of a latch coupler;

FIG. 6 is a perspective view of a third example of a latch coupler.

### DETAILED DESCRIPTION OF A PREFERRED EMBODIMENT

While this invention is susceptible of embodiment in many different forms, there are shown in the drawings and will be described in details herein, one specific embodiment of a base structure for a truck bed extension and ramp system. It should be understood that the present disclosure is to be considered as an example of the principles of the invention and is not intended to limit the invention to the embodiment illustrated and described.

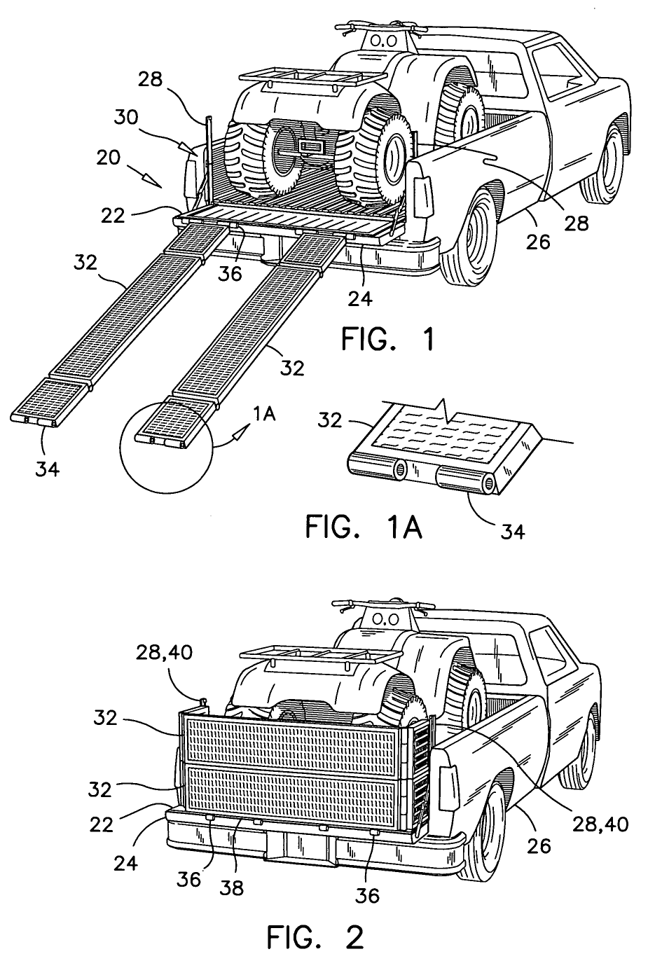

The preferred base structure 20 is illustrated with a pair of extended ramp members in use in FIG. 1, and with the ramp members in a stowed mode defining a truck bed extension in FIG. 2.

The base structure 20 has a horizontal U-shaped frame 22 which has a planar configuration and dimensions as to form a margin over the tailgate 24 of a pickup truck 26. A post 28 extends vertically at each end of the U-shaped frame 22. Each post 28 has a tailgate-latch coupler 30 movably mounted thereon for attachment to the tailgate latch member on the truck box. These tailgate-latch couplers 30 are better illustrated in FIGS. 4-6.

Each ramp member 32 has end segments that are foldable from a main segment as may be understood from the illustrations in FIGS. 1 and 2. When these end segments are folded, the ramp member 32 has edge-wise dimensions and configuration that are substantially the same as a layout of the U-shaped frame 22.

Each ramp member 32 has hinge bushings 34 on its extremities as may be understood from the illustration in FIG. 1A. The U-shape frame 22 also has anchor bushings 36 mounted to the cross-member 38 of the U-shaped frame for alignment with the hinge bushings 34.

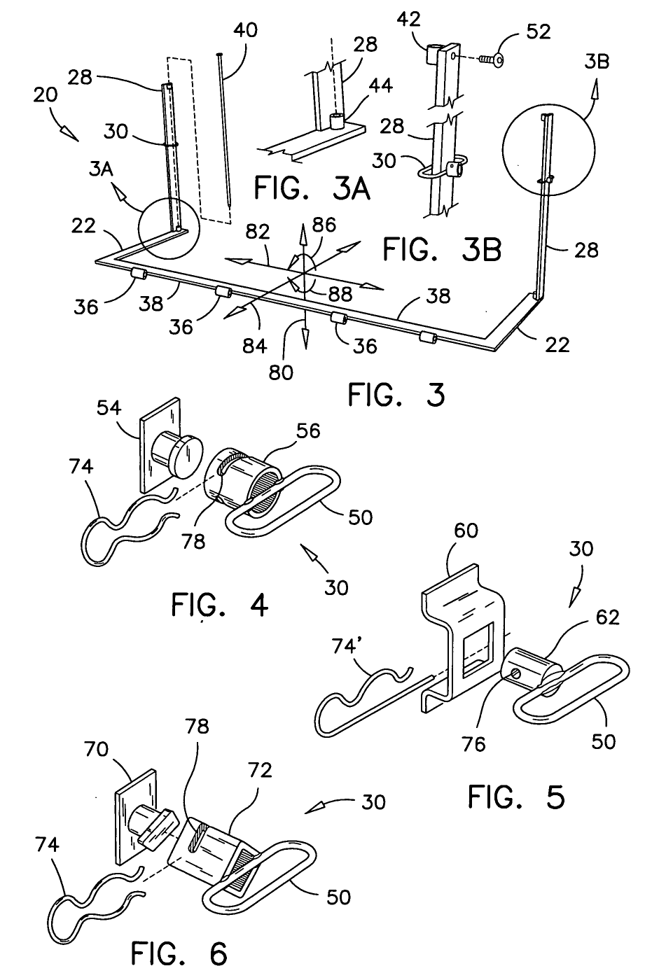

In use, one end of each ramp member 32 is held to the U-shaped frame by means of a pair of pins 40 fitly extending through the hinge bushings 34 and the anchor bushings 36 in a way that is well known to those skilled in the art. One of the pins 40 mentioned above is better illustrated in FIG. 3. In this illustration, the pin 40 is shown in its alternate orientation when it is used to retain the ramp members 32 in a stowed mode over the tailgate 24 of the pickup truck.

As may be understood from FIG. 2, a stowed mode is when both ramp members 32 are laid edge-to-edge over each other, and are mounted edge-wise over the U-shaped frame 22.

The preferred base structure 20 is illustrated in greater details in FIGS. 3, 3A and 3B. The base structure 20 is preferably made of structural steel and has stiffness to resist the stresses associated with its application. Each post 28 has a first sleeve 42 affixed to its upper end and a second sleeve 44 affixed to its lower end. As mentioned before, a pair of pins 40, are used the retain the ramp members 32 to the posts 28. Each pin 40 is long enough to engage in both the first and second sleeves 42, 44.

When the ramp members 32 are folded and in a stowed position as shown in FIG. 2, the hinge bushings 34 on their extremities are placed in alignment with each other and in alignment with the first and second sleeves 42, 44 on a same post 28 such as shown in FIG. 2. The ramp members 32 are secured to that post 28 by inserting one of the pins 40 through the first sleeve 42, through the hinge bushings 34 of the ramp members 32 and into the second sleeve 44.

The preferred base structure 20 is held to the pickup truck 26 by means of a pair of latch couplers 30 having connectors with dimensions to fitly engaged the tailgate latch members on the truck box. Three models of latch couplers are illustrated in FIGS. 4-6 respectively.

Each tailgate-latch coupler 30 comprises a chain link 50 which has dimensions to slide freely along a respective post 28. For the purpose of mounting each tailgate-latch coupler 30 to one of the posts 28, the first sleeve 42 on each post 28 is preferably mounted to this post in a detachable manner, such as with a screw 52 for example.

Each tailgate-latch coupler 30 has a latch connector mounted to the chain link 50. When the pickup truck has a pin type tailgate latch member 54 on its tailgate latch member, the latch connector is a cylindrical socket 56 as illustrated in FIG. 4. When the tailgate latch member comprises a holed bracket 60 on the truck box, then the latch connector is a pin 62 as illustrated in FIG. 5. Similarly, when the tailgate latch member comprises a square pin with a bevelled head 70, the latch connector is a square socket 72 as illustrated in FIG. 6. Although only three latch connectors 56, 62 and 72, have been illustrated herein, other latch connectors are possible and would become apparent to those skilled in the art in the light of the present disclosure and the examples provided.

Each latch connector is preferably held to its respective latch member by a hitch clip 74 or hitch pin clip 74′ extending through a hole 76 in the pin-type connector 62, or extending into slots 78 in the socket 56 or 72, for engagement with the shoulder on the pin-type latch 54 or 70.

Referring back to FIG. 3, the functions and advantages of the preferred base structure 20 will be explained. When both ramp members 32 are in a folded and stowed position over the base member 20, in a truck bed extension mode, the weight of the ramp members 32 prevents the truck bed extension from moving in vertical directions 80. Also, because both posts 28 are held between the side walls of the truck box, the truck bed extension cannot move in lateral directions 82 relative to the truck box. Because the tailgate-latch couplers 30 are retaining each posts 28 to the truck box, the truck bed extension cannot move in longitudinal directions 84 relative to the truck box.

When the ramp members 32 are in a deployed mode and are attached to the anchor bushings 36, the latch couplers 30 hold the base structure 20 in place and prevent the base structure 20 from tilting in a direction represented by arrow 86 in FIG. 3, when a load is applied on the ramp members. Because of the functions of the posts 28 and the couplers 30, the base structure 20 prevents the tailgate from tilting upward in a direction represented by arrow 88, when the pickup truck drives on rough roads for example.

Because of the posts 28 and the design versatility of the tailgate-latch couplers 30, a same base structure 20 is easily fitted to different makes of pickup trucks. Moreover, because of the base structure 20, a truck bed extension and a tailgate ramp system can be fitted to a pickup truck without making any modification to the truck itself.

The above description, illustrations and examples provided should not be construed as limiting the scope of the invention, which is defined by the appended claims.

What is claimed is:

1. A base structure for a truck bed extension and ramp system, comprising;
a U-shaped planar frame having a horizontal orientation and opposite ends; said U-shaped frame having dimensions similar to a tailgate of a pickup truck;
a pair of posts extending vertically from said ends; and
a tailgate-latch coupler movably mounted on each of said posts; said tailgate-latch coupler having means for attachment to a tailgate latch member on a tailgate latch of a pickup truck.

2. The base structure as claimed in claim 2, wherein said tailgate-latch coupler comprises a chain link loosely encircling said post.

3. The base structure as claimed in claim 2, wherein each of said post has a first sleeve affixed to an upper end thereof and a second sleeve affixed to a lower end thereof in alignment with said first sleeve, and a pin extending in said first and second sleeves.

4. The base structure as claimed in claim 3, wherein said first sleeve is removably affixed to said upper end of said post.

5. The base structure as claimed in claim 3, wherein said U-shaped frame comprises a cross-member and said cross-member has a series of anchor bushings mounted thereto in alignment with each other.

6. The base structure as claimed in claim 5 wherein said anchor bushings have dimensions for fitly receiving said pins.

7. The base structure as claimed in claim 2, wherein said tailgate-latch coupler has a socket mounted to said chain link, and said socket has dimensions for fitly enclosing a tailgate latch pin.

8. The base structure as claimed in claim 2, wherein said tailgate-latch coupler has a shoulder-type pin mounted to said chain link, and said pin has dimensions for mounting into a holed-bracket of a tailgate latch.

9. The base structure as claimed in claim 2, wherein said tailgate-latch coupler comprises a hitch pin clip mounted thereto for engaging a tailgate latch member and for retaining said tailgate latch coupler to said tailgate latch member.

10. An attachment for a pickup truck comprising;
a base structure having a U-shaped planar frame having a horizontal orientation and opposite ends; said U-shaped frame having dimensions similar to a tailgate of said pickup truck; a pair of posts extending vertically from said ends; and a tailgate-latch coupler movably mounted on each of said posts; said tailgate-latch coupler having means for attachment to a tailgate latch member on a tailgate latch of said pickup truck, and
a pair of folded ramp members laid edge-to-edge over each other and mounted edge-wise on said U-shaped frame;
said ramp members being secured to said base structure by pins connecting extremities of said ramp members to said posts.

11. The attachment for a pickup truck, as claimed in claim 10, wherein said tailgate-latch coupler comprises a chain link loosely encircling said post.

12. The attachment for a pickup truck, as claimed in claim 10, wherein each of said posts has a first sleeve affixed to an upper end thereof and a second sleeve affixed to a lower end thereof in alignment with said first sleeve, and each of said pin extends in said first and second sleeves on a respective one of said posts.

13. The attachment for a pickup truck as claimed in claim 10, wherein said U-shaped frame comprises a cross-member and said cross-member has a series of anchor bushings mounted thereto in alignment with each other.

14. The attachment for a pickup truck as claimed in claim 13 wherein said anchor bushings have dimensions for fitly receiving said pins.

15. The attachment for a pickup truck as claimed in claim 10, wherein said tailgate-latch coupler has a socket mounted to said chain link, and said socket has dimensions for fitly enclosing a tailgate latch pin.

16. The attachment for a pickup truck as claimed in claim 10, wherein said tailgate-latch coupler has a shoulder-type pin mounted to said chain link, and said pin has dimensions for mounting into a holed-bracket of a tailgate latch member.

17. The attachment for a pickup truck as claimed in claim 10, wherein said tailgate-latch coupler comprises a hitch pin clip mounted thereon for engaging a tailgate latch member and for retaining said tailgate latch coupler to said tailgate latch member.

18. An attachment for a pickup truck comprising;
a base structure having a U-shaped planar frame having a horizontal orientation, opposite ends and a cross member between said opposite ends; said U-shaped frame having dimensions similar to a tailgate of said pickup truck; a pair of posts extending vertically from said ends; and a tailgate-latch coupler movably mounted on each of said posts; said tailgate-latch coupler having means for attachment to a tailgate latch member on a tailgate latch of said pickup truck, and;
a pair of ramp members extending from said cross member and being retained to said cross member by pins connecting extremities of said ramp members to said cross member.

19. The attachment for a pickup truck as claimed in claim 18, wherein said cross member have anchor bushings affixed thereto in alignment with each other, and said ramp members having hinge bushings on extremities thereof and said anchor bushings and said hinge bushings being in alignment with each other and enclosing said pins.

20. The attachment for a pickup truck as claimed in claim 18, wherein said ramp members are foldable and have folded dimensions similar to overall horizontal measurements of said U-shaped frame.
